(19) United States
(12) Patent Application Publication
(10) Pub. No.: US 2013/0171686 A1
(43) Pub. Date: Jul. 4, 2013

(54) METHOD OF TREATING MINE-INFLUENCED WATER AND SOIL

(71) Applicants: Donald F. Perry, Hermitage, PA (US); Tyler D. Perry, Hermitage, PA (US); Matthew A. Perry, Hermitage, PA (US)

(72) Inventors: Donald F. Perry, Hermitage, PA (US); Tyler D. Perry, Hermitage, PA (US); Matthew A. Perry, Hermitage, PA (US)

(21) Appl. No.: 13/714,297

(22) Filed: Dec. 13, 2012

Related U.S. Application Data
(60) Provisional application No. 61/569,971, filed on Dec. 13, 2011.

(51) Int. Cl. B09C 1/10; C02F 3/00

(52) U.S. Cl. CPC B09C 1/10; C02F 3/00
USPC 435/34; 210/610

(57) ABSTRACT

The present invention is directed to a method of trans-seasonal bioremedial treating of mine-influenced water and soil (MIWAS) in situ with microorganisms for removal of contaminants containing heavy metals compounds. The method comprises the steps of: a) sampling indigenous microorganisms from the MIWAS site being treated; b) identifying and/or isolating indigenous microorganisms that consume selected compounds to be treated in the MIWAS; c) propagating at least one of the indigenous microorganisms identified or isolated in step b); and d) reintroducing propagated microorganisms either on the soil surface or subsurface at the MIWAS site together with a source of nutrients and a carbon source for the microorganisms; wherein when the microorganisms, nutrients, and carbon source are reintroduced on the soil surface, they are subsequently buried.

### RELATED APPLICATION

The present application claims the benefit of provisional patent application Ser. No. 61/569,971 filed Dec. 13, 2011, entitled “Method of Treating Mine-Influanced Water and Soil.”

### FIELD OF THE INVENTION

The present invention relates to methods of treating mine-influenced water and soil to remove contaminants therefrom and more specifically to methods that can utilize a sites native microbial population.

### BACKGROUND OF THE INVENTION

The mining industry has prioritized the management of contaminants in mine-influenced water and soil (MIWAS), which may also be referred to as mining influenced water and soil or other similar phrases.

Physical methods for management of contaminants in MIWAS such as adsorption, filtration or extractions are effective for some wastes. Unfortunately, additional treatments are often required to complete the decontamination because these treatments merely separate out the wastes but do not destroy the waste by converting it into a nonhazardous form. Chemical treatment can be used on some wastes, but there may be hazardous by-products or sludges produced by treatment. Wastes may be isolated or altered through methods such as stabilization, solidification or encapsulation, but the problem of storage of the contained waste is created.

Incineration is an expensive method and requires a large consumption of energy resources to remove the wastes and is largely impractical as applied to MIWAS remediation.

Biological treatment is another method of remediation that has been used for decades in wastewater treatment and composting processes. Such processes in settling ponds and the like also produce sludge and wastewater that may require further treatment and disposal. Bioremediation occurs naturally at a low level and a very slow rate, even under ideal situations, in the biodegradation of material and wastes. Technologies using bioremediation methods take advantage of the naturally present degradative organisms to decontaminate air, soil or water.

Currently, bioremediation methods fall into three broad categories-land treatment, bioreactors, and in situ treatment. In land treatment, the contaminated materials are mixed into surface soils or composted. These systems require the addition of bulking agents, aeration systems, water and nutrients to enhance the actions of the biological organisms. Bioreactors are another means for bioremediation of contaminated materials such as MIWAS. Lagoons, ponds, tanks or reactors with bacterial growth, are designed to decontaminate groundwater or such mixtures as slurries of MIWAS. These methods may require that the MIWAS to be excavated, pumped or trucked to a distant site where the bioreactor is located. Additionally, the solids may have to be handled and sorted. After treatment at the bioreactor, any incompletely cleaned water or slurry would have to be transported elsewhere.

On-site usage of bioreactors can eliminate the cost of trucking the material to the bioreactor, but the cost of excavation or handling of the soils is still present. These are generally not insignificant costs. In addition, the site may not lend itself to the presence of a bioreactor or support for the personnel necessary to oversee and upkeep the reactor.

Another type of bioremediation, in situ remediation, utilizes contaminant-degrading microorganisms which are or may be made present (i.e. introduced) at the contaminated site. These organisms are capable of some kind of degradation of a contaminant; however their decontaminating action (without assistance) typically proceeds at too low a level and too slow a rate to effectively decontaminate the area. The growth of the microorganisms is often be enhanced by the addition of oxygen and/or nutrients.

The management of selenium (Se) as one heavy metal contaminant of MIWAS is particularly illustrative of the challenges facing cost effective management of MIWAS. Selenium (Se) is a naturally occurring element that is often found in shale rock underlying primarily the central and western USA, as well as other areas throughout the world. It is found in the environment where there are outcrops of this shale, or where the Se containing sediments are disturbed, such as in mining.

It has been noted that the handling of selenium wastes in MIWAS will increasingly become a limiting factor in the ability of the mining industry to grow. As background, waste rock is the primary source of selenium in coal mining operations. When exposed to water, various selenium species will leach or migrate from the rock and enter the environment. Selenium in mine runoff most often occurs in the soluble form and is commonly found in mining wastewaters in concentrations ranging from 3 to over 12,000 μg/L. The United States National Primary Drinking Water standard MCL is 50 μg/L for selenium, and the National Fresh Water Quality Standard is 5 μg/L for selenium. The U.S. Fish and Wildlife Service recommended that the National Fresh Water Quality Standard be lowered to 2 μg/L for selenium. In Canada, stakeholders must reduce the levels to 1 μg/L for surface water if they desire to avoid monitoring requirements.

A number of bioremediation technologies, including technologies for treating selenium, are described in the patent literature.

Environmental Improvement Technologies, Inc. developed a process for removing contaminants from soil and an associated subsurface groundwater aquifer as described in U.S. Pat. No. 5,221,159 which is incorporated herein by reference, wherein an injection well is drilled through the “vadose zone” to a depth below the water table defining the upper boundary of the aquifer. An extraction well is established to a depth above the water table. Oxygenated gas is injected under pressure through the injection well while a vacuum is applied to the extraction well. Contaminants are removed from the groundwater aquifer and from the vadose zone by a combination of physical, chemical, and biochemical processes. Additional biochemical cleansing may occur at ground level prior to venting of extracted, contaminated air.

Plant Research Laboratories Inc. disclosed in U.S. Pat. No. 5,264,018, which is incorporated herein by reference, a method of decontaminating soil by applying to the soil an oxygen delivery vehicle such as peroxides of calcium, potassium or magnesium or mixture thereof in an amount which substantially increases the population of microorganism in the soil that digest pollutants.

Tuboscope Vetco International disclosed in U.S. Pat. No. 5,302,287, which is incorporated herein by reference, an in situ method of cleaning soil and/or water which comprises breaking up contaminated soil, admixing soil with water and a biodegradable detergent in a proportion effective to obtain an aqueous slurry where the soil, any contaminant and the detergent interact to form contaminant-detergent formations. This step is followed by allowing the slurry to stand under conditions effective to permit any contaminant-detergent formations to rise in the aqueous slurry, separating the contaminant-detergent formations from the aqueous slurry which is now comprising partially decontaminated soil and water, then separating the soil from the water. The process is repeated for the cleaning and separation steps until the soil has less contaminant than a predetermined value, and eventually the method allows the activating agent to interact with the soil microorganisms in the aqueous mixture under conditions effective to further remove contaminants remaining therein.

The University of Texas developed a process disclosed in U.S. Pat. No. 5,352,608, which is incorporated herein by reference, teaching a bioreduction method for contaminants such as selenium that utilize proteobacteria that show unusually high level resistance to a wide range of metal oxides and oxyanions.

The University of California developed a process disclosed in U.S. Pat. No. 5,487,834, which is incorporated herein by reference, which teaches a method for purifying contaminated subsurface groundwater that involves contacting the contaminated subsurface groundwater with methanotrophic or heterotrophic microorganisms which produce contaminant-degrading enzymes.

Spelman College developed a process disclosed in U.S. Pat. No. 5,736,048 which is incorporated herein by reference, and which discloses a process of remediating chemical contamination of a pond contaminated with one or more toxic heavy metals or aromatic compounds, the steps include: preparing a silage of grass clippings, placing the silage on the surface of a pond, and inoculating the pond with an alga and Bacillus cereus in sufficient quantities to cause a mixed algal and bacterial bloom to form on the pond surface and become annealed to the silage, leaving the silage with the annealed bloom on the surface of the pond for a sufficient amount of time to allow the bloom to withdraw at least some of the toxic heavy metal content or to degrade at least some of the aromatic compound content of the pond, and removing the silage with the annealed bloom from the pond.

Rutgers University developed a process disclosed in U.S. Pat. No. 5,809,693 which is incorporated herein by reference, and which discloses compositions for enhancing metal uptake of plants, such as members of the family Brassicaceae, with a method that comprises treating the roots, plants, seeds, and/or soil in which the plants are grown, with metal-uptake altering microorganisms, preferably of the bacterial genus Pseudomonas and Bacillus.

Auburn University developed a process disclosed in U.S. Pat. No. 5,833,855 which is incorporated herein by reference, and which discloses a method for removing heavy metals and halogenated hydrocarbons from contaminated ground waters wherein the method provides utilizing a treatment solution comprising a soluble source of organic carbon, ferrous iron, and sulfate. Additionally, the treatment solution may comprise sulfate reducing bacteria as well as nutrients for bacterial metabolism. The treatment is designed to stimulate the growth of naturally occurring sulfate reducing bacteria such that the metals are co-precipitated in iron sulfide and the hydrocarbons are reduced to innocuous byproducts.

RMT, Inc. developed a process disclosed in U.S. Pat. No. 6,001,252 which is incorporated herein by reference, and which discloses method for in situ anaerobic dehalogenation of a halogenated organic compound in a groundwater plume reduces or prevents indigenous aerobic microorganisms from competing for a supplied electron donor with an anaerobic microorganism that reductively dehalogenates the organic compound when an electron donor is available. The method includes the step of injecting in situ into a groundwater-saturated matrix within or upgradient of a source of the organic compound a deoxygenated aqueous solution that comprises an electron donor to facilitate reductive dehalogenation of the organic compound.

Arcadis Geraghty & Miller, Inc. developed a process disclosed in U.S. Pat. No. 6,116,816 which is incorporated herein by reference, and which discloses method and system for removing contaminants from the phreatic zone, also known as the saturation zone, or groundwater. A barrier wall is constructed below the ground surface and in the path of flow of a contaminated groundwater plume. A well is constructed in advance of the barrier wall and is connected to the barrier wall via a pipe. Various remediation media may be lowered into the well to perform remediation on the contaminated groundwater before it passes through the barrier wall. Similar teachings are found in Arcadis Geraghty & Miller, Inc.'s U.S. Pat. Nos. 6,143,177 and 6,632,364 which are also incorporated herein by reference.

Weber State University developed a process disclosed in U.S. Pat. No. 6,183,644 which is incorporated herein by reference, and which discloses a method in which dissolved selenium is removed from contaminated water by treating the water in a reactor containing selected endemic and other selenium reducing organisms.

General Electric Company developed a process disclosed in U.S. Pat. No. 6,238,570 which is incorporated herein by reference, and which discloses a method for treating aqueous composition contaminants wherein a non-iron sulfide is introduced into an iron-containing zone to form ferrous sulfide and a contaminated aqueous composition is then contacted with the ferrous sulfide to react with said contaminants. See a similar teaching in U.S. Pat. No. 6,464,864, which is incorporated herein by reference.

Remediation Products, Inc. developed a process disclosed in U.S. Pat. No. 6,787,034 which is incorporated herein by reference, and which discloses a bioremediation composition for in situ bioremediation of soil and/or groundwater contaminated with hydrocarbons, comprising an adsorbent capable of adsorbing said hydrocarbons, a mixture of facultative anaerobes capable of metabolizing said hydrocarbons under sulfate-reduction conditions, a sulfate-containing compound that releases sulfate over a period of time, and a nutrient system for promoting growth of said anaerobes, wherein said nutrient system includes a sulfide scavenging agent.

Global Biosciences, Inc. developed a process disclosed in U.S. Pat. No. 6,923,914 which is incorporated herein by reference, and which discloses remediating metal contaminants using hydrocarbons which stimulate the growth of hydrocarbon-utilizing bacteria.

Inventor Sorenson's U.S. Pat. No. 7,138,059, which is incorporated herein by reference, teaches a method for in situ bioremediation of contaminants which includes adding an electron donor to ground water in an amount sufficient for a microbe in the ground water to use the electron donor for reducing the contaminant into an innocuous derivative thereof. Illustratively, the electron donor contains about 0.1 to 75% by weight of chitin, such as crustacean shell, partially deproteinized crustacean shell, ground mushrooms, or a fungal fermentation broth. The chitinous electron donor can be added to the ground water as a particulate solid or aqueous slurry.

Delta Environmental Consultants, Inc.'s U.S. Pat. No. 7,138,060 which is incorporated herein by reference, discloses an in situ treatment of contaminated groundwater which includes identifying a site contaminated with a pollutant susceptible to degradation by in situ, sulfate-reducing microorganisms, wherein an amount of sulfate needed to support metabolization of the contaminants is estimated. The estimated amount of sulfate is applied to the site.

JRW Bioremediation, LLC and Penn State University jointly developed a process disclosed in U.S. Pat. No. 7,959,806 which is incorporated herein by reference, and that teaches a method for treating MIWAS wherein a number of electron donors are disclosed, including chitin complex-containing materials. The chitin complex-containing materials may modify the pH and reductive-oxidation potential of the contaminated media within the subsurface or within a treatment cell to facilitate metal removal through biological, chemical, and physical means, or a combination thereof. Bioremediation enhancing agents such as yeast products may also be used to facilitate microbial treatment of the contaminated sources. The yeast products may work with microbes to improve the rate of contaminant removal and promote microbial growth.

Southern Company Services, Inc. developed a process disclosed in U.S. Pat. No. 8,157,476 which is incorporated herein by reference, and that teaches an in-situ method for immobilizing a contaminant in a medium, comprising: contacting a medium in-situ with a chemical reagent, the medium comprising a contaminant, wherein the contacting the medium in-situ with a chemical reagent does not involve physical mixing of the medium and the chemical reagent; and immobilizing at least a portion of the contaminant in the medium in-situ to yield an immobilized contaminant in the medium, wherein the immobilized contaminant in the medium is neither extracted from the medium nor degraded by the chemical reagent.

Many of the above bioremediation systems are highly temperature dependent and when operated at or near the surface will have limited application during much of the year in northern climates. Further many of the above described solutions represent effectively academic solutions that fail to properly address cost concerns associated with the described process.

It would be desirable to provide a cost effective method of treating mine-influenced water and soil that overcomes the disadvantages of the prior art by allowing for on-site treatment independent of seasonal ambient temperatures and eliminating the generation of sludge and other waste and can do so in a cost effective manner.

### SUMMARY OF THE INVENTION

One aspect of the present invention is directed to a method of trans-seasonal bioremedial treating of mine-influenced water and soil (MIWAS) in situ with microorganisms for removal of contaminants containing heavy metals compounds, such as selenium. The method comprises the steps of:
a) sampling indigenous microorganisms from the MIWAS site being treated;
b) identifying and/or isolating indigenous microorganisms that consume selected compounds to be treated in the MIWAS;
c) propagating at least one of the indigenous microorganisms identified or isolated in step b); and
d) reintroducing propagated microorganisms either on the soil surface or subsurface at the MIWAS site together with a source of nutrients and a carbon source for the microorganisms; wherein when the microorganisms, nutrients, and carbon source are reintroduced on the soil surface, they are subsequently buried.

Another aspect of the present invention is directed to a method of trans-seasonal bioremedial treating of mine-influenced water and soil (MIWAS) in situ with microorganisms for removal of contaminants containing sulpher compounds. The method comprises the steps of:
a) sampling indigenous microorganisms from the MIWAS site being treated;
b) identifying and/or isolating indigenous microorganisms that consume selected compounds to be treated in the MIWAS;
c) propagating at least one of the indigenous microorganisms identified or isolated in step b); and
d) reintroducing propagated microorganisms either on the soil surface or subsurface at the MIWAS site together with a source of nutrients and a carbon source for the microorganisms; wherein when the microorganisms, nutrients, and carbon source are reintroduced on the soil surface, they are subsequently buried.

The steps of the process outlined above may be performed in an alternate order and multiple steps may be performed simultaneously. Also, one or more steps may be repeated or skipped as necessary to obtain desired results depending upon the discovered on-site conditions.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “isolate” is meant that a desired microorganism is selectively bred and propagated to the general exclusion of other microorganisms that are not useful to the process of the present invention.

By “consume” is meant that a compound is used by a microorganism in a biochemical reaction, such as by digestion or respiration. For example, oxides of heavy metals such as selenium may be reduced by a microorganism so that the scavenged oxygen may be used by the organism in respiration, thereby consuming the compound.

In the method of the present invention, mine-influenced water and soil (MIWAS) is treated in situ for removal of contaminants such as heavy metals, in particular, selenium. The method is substantially independent of ambient temperatures as opposed to methods using surface or near surface pooling and/or treatment and therefore the method according to the present invention as set forth below allows for trans-seasonal bioremediation. The method of the present invention is suitable for use year-round.

The method of the present invention is designed to stimulate and/or enhance the activity of indigenous (naturally occurring) microorganisms at a mine effluent-contaminated site. However, if such microorganisms are lacking because they are not present or at very low naturally occurring levels at a particular site, they can be introduced into the contaminated site during the treatment process.

In a first step of the method of the present invention, indigenous microorganisms are sampled from the MIWAS site being treated. Such sampling or selection methods are well known in the art and may be relatively straightforward; organisms at the contaminated site are likely to have undergone natural selection, particularly given the short time (typically one week) between generations of bacteria. Thus, the most ideal microorganisms for remediation are likely to already exist at the contaminated site because the site-specific contaminants have driven natural selection.

Indigenous microorganisms that consume selected contaminants are then identified and/or isolated and may be selectively bred. The identification and/or isolation of the desirable microorganisms allows for selective breeding of these identified or isolated microorganisms. One method of isolation is altering the environment of the sampled microorganisms wherein substantially only the contaminants to be reduced are present such that, in short order, the resulting microorganisms (also called the ideal microorganisms) will essentially be those that can have the desired reducing effect. The identification and or isolation of the desirable microorganisms also allows for preferential selection and creation of the nutrients and food source and associated material for propagation before reintroduction, and for on-site maintaining and possible growth of the ideal desirable microorganisms population.

At least one of the ideal microorganisms for remediation identified as noted above may be propagated for reintroduction at the contaminated site. Such propagation may be done offsite and under controlled conditions to enhance the presence or percentage of desirable indigenous microorganisms.

At the MIWAS site, a bioremedial composition comprising propagated microorganisms, a source of nutrients, and a carbon source for the microorganisms may be reintroduced subsurface. At sites that have a sufficient indigenous microorganism population, a bioremedial composition comprising simply a source of nutrients and a carbon source may be introduced. Alternatively, the individual components of the bioremedial composition may be added alone or in various combinations at different locations on the contaminated site.

The bioremedial composition may be injected through existing ports, access sites or wells or those drilled specifically for bioremediation. The number and location of injection sites, pumping rates, and total amounts of bioremedial composition added will depend upon several factors including the geological conditions at the site, for example, porosity, permeability, and variability due to rock strata, etc.; concentration of contaminants; time constraints; required compliance levels of contaminants in groundwater; and the like. Optimal points of reintroduction may be determined by the location of groundwater plumes.

Alternatively or additionally, the bioremedial composition may be introduced on the soil surface and subsequently buried. A separate, additional source of nutrients and a carbon source for indigenous microorganisms may also be introduced above the surface of the soil and subsequently buried. This step may take place during mining operations by covering the bioremedial composition with mining debris. Typically, the bioremedial composition is injected or buried at a depth sufficient to allow the composition to reach underground water sources.

A source of organic carbon is included in the bioremedial composition to provide a substrate for the microorganisms. One or more of several different carbon sources may be utilized such as acetate, lactate, propionate, butyrate, formate, ethanol, and the like. Chitin is highly biodegradable and breaks down into low molecular weight organic acids such as acetic acid, propionic acid, butyric acid, and pyruvic acid. Chitin also contains a significant amount of nitrogen, which provides a carbon to nitrogen ratio ideally suited for supporting bacterial growth. In addition, because it is a porous solid, chitin provides both a support for bacterial colonization and a long-term source of carbon. The choice of carbon source can enhance the growth and activity of preferred microorganisms and may be selected accordingly. The carbon source is provided in an amount sufficient to provide for growth and metabolism of the microorganisms.

Nutrients for growth and metabolism of the microorganisms are also provided in the bioremedial composition. Compounds containing nitrogen and/or phosphorous are typically included, often in the form of proteins or ammonium phosphate.

After an initial treatment, the site may be monitored such as by groundwater or effluent sampling and qualitative and/or quantitative analysis for contaminant content, and one or more of the process steps can be repeated if necessary until the site is self-sufficient at maintaining contaminant levels at or below a pre-determined acceptable level. For example, the process may be conducted and repeated as necessary until selenium compounds are present in the MIWAS in amounts less than 5 parts per billion, so as to meet the National Fresh Water Quality Standard for selenium. The method of the present invention is cost effective for amounts of 2 μg/L for selenium and even 1 μg/L for selenium in surface water.

The present invention envisions that any site will undergo a sampling of indigenous microorganisms from the MIWAS site being treated and that there will be an identification and/or isolation of indigenous microorganisms that reduce selected heavy metal compounds to be treated in the MIWAS. It is expected that some sites may yield sufficient populations of ideal indigenous microorganisms so that the subsequent propagating at least one of the indigenous microorganisms is no longer required for that site. In this case, the reintroduction of a bioremedial composition may not include propagated microorganisms, but only a selected source of nutrients, and a selected carbon source for the desirable indigenous microorganisms subsurface at the MIWAS site.

The method of the present invention can be extended to address other analogous MIWAS treatments such as acid mine drainage. The above descriptions are intended to be illustrative of the present invention and not be restrictive thereof. A number of variations may be made to the present invention without departing from the spirit and scope thereof. The scope of the present invention is defined by the appended claims and equivalents thereto.

What is claimed is:

1. A method of trans-seasonal bioremedial treating of mine-influenced water and soil (MIWAS) in situ with microorganisms for removal of contaminants containing heavy metals, comprising the steps of:
a) sampling indigenous microorganisms from the MIWAS site being treated;
b) identifying indigenous microorganisms that reduce selected heavy metal compounds to be treated in the MIWAS;
c) propagating at least one of the indigenous microorganisms identified in step b); and
d) reintroducing a bioremedial composition comprising propagated microorganisms, a source of nutrients, and a carbon source for the microorganisms subsurface at the MIWAS site.

2. The method of claim 1 wherein the contaminants comprise selenium compounds.

3. The method of claim 1 wherein in step c), propagation of the microorganisms occurs offsite.

4. The method of claim 1 wherein in step d), the bioremedial composition is reintroduced subsurface at a depth sufficient to allow the bioremedial composition to reach underground water sources.

5. The method of claim 1 wherein the site is monitored after treatment, and one or more of steps a) through d) are repeated until the site is self-sufficient at maintaining contaminant levels at or below a pre-determined acceptable level.

6. The method of claim 5 wherein after treatment, selenium compounds are present in the MIWAS in amounts less than 5 parts per billion.

7. The method of claim 1 wherein an additional source of nutrients and a carbon source for indigenous microorganisms are introduced above the surface of the soil and subsequently buried.

8. The method of claim 7 wherein the additional source of nutrients and carbon source for indigenous microorganisms are buried during mining operations by covering the additional source of nutrients and carbon source with mining debris.

9. A method of trans-seasonal bioremedial treating of mine-influenced water and soil (MIWAS) in situ with microorganisms for removal of contaminants containing heavy metals, comprising the steps of:
a) sampling indigenous microorganisms from the MIWAS site being treated;
b) identifying indigenous microorganisms that reduce selected heavy metal compounds to be treated in the MIWAS;
c) propagating at least one of the indigenous microorganisms identified in step b);
d) reintroducing propagated microorganisms on the soil surface at the MIWAS site together with a source of nutrients and a carbon source for the microorganisms; and
e) burying the reintroduced microorganisms, source of nutrients, and carbon source.

10. The method of claim 9 wherein the reintroduced microorganisms, source of nutrients, and carbon source are buried during mining operations by covering the reintroduced microorganisms, source of nutrients, and carbon source with mining debris.

11. The method of claim 9 wherein the contaminants comprise selenium compounds.

12. The method of claim 9 wherein in step c), propagation of the microorganisms occurs offsite.

13. The method of claim 9 wherein the site is monitored after treatment, and one or more of steps a) through e) are repeated until the site is self-sufficient at maintaining contaminant levels at or below a pre-determined acceptable level.

14. The method of claim 13 wherein after treatment, selenium compounds are present in the MIWAS in amounts less than 5 parts per billion.

15. A method of trans-seasonal bioremedial treating of mine-influenced water and soil (MIWAS) in situ with microorganisms for removal of contaminants containing heavy metals or sulpher compounds, comprising the steps of:
a) sampling indigenous microorganisms from the MIWAS site being treated;
b) isolating indigenous microorganisms that reduce selected heavy metal compounds to be treated in the MIWAS;
c) propagating at least one of the indigenous microorganisms isolated in step b); and
d) reintroducing propagated microorganisms subsurface at the MIWAS site together with a source of nutrients and a carbon source for the microorganisms.

16. The method of claim 15 wherein the contaminants comprise selenium compounds.

17. The method of claim 15 wherein in step c), propagation of the microorganisms occurs offsite.

18. The method of claim 15 wherein in step d), the propagated microorganisms are reintroduced subsurface at a depth sufficient to allow the microorganisms to reach underground water sources.

19. The method of claim 15 wherein the site is monitored after treatment, and one or more of steps a) through d) are repeated until the site is self-sufficient at maintaining contaminant levels at or below a pre-determined acceptable level.

20. The method of claim 19 wherein after treatment, selenium compounds are present in the MIWAS in amounts less than 5 parts per billion.
